(19) United States
(12) Patent Application Publication
(10) Pub. No.: US 2026/0339460 A1
(43) Pub. Date: Oct. 29, 2026

(54) DISPLAY PANEL AND DISPLAY DEVICE

(71) Applicant: Xiamen Tianma Optoelectronics Co., Ltd., Xiamen (CN)

(72) Inventor: Yixin CHEN, Xiamen (CN)

(21) Appl. No.: 19/298,565

(22) Filed: Aug. 13, 2025

(30) Foreign Application Priority Data
Apr. 27, 2025 (CN) 202510537955.9

(51) Int. Cl. G06F 3/041; G02F 1/1333; G02F 1/1343; G06F 3/044

(52) U.S. Cl. CPC G06F 3/0418; G02F 1/13338; G02F 1/134309; G06F 3/0412; G06F 3/0445; G06F 3/0446; G02F 2201/503; G06F 2203/04107

(57) ABSTRACT

A display panel and a display device are provided. The display panel includes: a display area and a non-display area surrounding the display area; a first substrate and a second substrate arranged opposite to each other; a liquid crystal layer located between the first substrate and the second substrate; and a conductive portion on a side of the first substrate close to the second substrate. The conductive portion is located in the non-display area and is grounded.

### CROSS-REFERENCE TO RELATED APPLICATION

This application claims the priority of Chinese Patent Application No.: 202510537955.9, filed on Apr. 27, 2025, the content of which is incorporated herein by reference in its entirety.

### TECHNICAL FIELD

The present disclosure generally relates to the field of display technology and, more particularly, relates to a display panel and a display device.

### BACKGROUND

As an important component of human-computer interaction, touch screens have been widely used in electronic products such as mobile phones and tablet computers.

In a touch screen in existing technology, a high-resistance film is usually set to ensure that a touch signal is not shielded. The square resistance of the high-resistance film is high such that the static electricity conduction effect of the high-resistance film is poor, which is not conducive to the release of static electricity in the touch screen. How to improve the electrical reliability of a touch screen and avoid electrostatic damage has become the research focus of relevant researchers.

### SUMMARY

One aspect of the present disclosure provides a display panel. The display panel includes: a display area and a non-display area surrounding the display area; a first substrate and a second substrate arranged opposite to the first substrate; a liquid crystal layer located between the first substrate and the second substrate; and a conductive portion on a side of the first substrate close to the second substrate. The conductive portion is located in the non-display area and is grounded.

Another aspect of the present disclosure provides a display device including a display panel. The display panel includes: a display area and a non-display area surrounding the display area; a first substrate and a second substrate arranged opposite to each other; a liquid crystal layer located between the first substrate and the second substrate; and a conductive portion on a side of the first substrate close to the second substrate. The conductive portion is located in the non-display area and is grounded.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a planar view of an exemplary display panel consistent with various disclosed embodiments in the present disclosure.

FIG. 2 illustrates a cross-sectional view of a display panel along an A-A′ direction in FIG. 1 consistent with various disclosed embodiments in the present disclosure.

FIG. 3 illustrates a planar view of another exemplary display panel consistent with various disclosed embodiments in the present disclosure.

FIG. 4 illustrates a cross-sectional view along a B-B′ direction of a display panel in FIG. 3 consistent with various disclosed embodiments in the present disclosure.

FIG. 5 illustrates another cross-sectional view along a B-B′ direction of a display panel in FIG. 3 consistent with various disclosed embodiments in the present disclosure.

FIG. 6 illustrates a planar view of another exemplary display panel consistent with various disclosed embodiments in the present disclosure.

FIG. 7 illustrates a structural schematic diagram of an exemplary first control circuit consistent with various disclosed embodiments in the present disclosure.

FIG. 8 illustrates a circuit schematic diagram of another exemplary first control circuit consistent with various disclosed embodiments in the present disclosure.

FIG. 9 illustrates a circuit schematic diagram of another exemplary first control circuit consistent with various disclosed embodiments in the present disclosure.

FIG. 10 illustrates a circuit schematic diagram of another exemplary first control circuit consistent with various disclosed embodiments in the present disclosure.

FIG. 11 illustrates a timing diagram of another exemplary first control circuit consistent with various disclosed embodiments in the present disclosure.

FIG. 12 illustrates a circuit schematic diagram of another exemplary first control circuit consistent with various disclosed embodiments in the present disclosure.

FIG. 13 illustrates a planar view of another exemplary display panel consistent with various disclosed embodiments in the present disclosure.

FIG. 14 illustrates a cross-sectional view along a C-C′ direction of a display panel in FIG. 13 consistent with various disclosed embodiments in the present disclosure.

FIG. 15 illustrates a planar view of another exemplary display panel consistent with various disclosed embodiments in the present disclosure.

FIG. 16 illustrates a cross-sectional view along a D-D′ direction of a display panel in FIG. 15 consistent with various disclosed embodiments in the present disclosure.

FIG. 17 illustrates another cross-sectional view along a D-D′ direction of a display panel in FIG. 15 consistent with various disclosed embodiments in the present disclosure.

FIG. 18 illustrates an enlarged view of region E of a display panel in FIG. 15 consistent with various disclosed embodiments in the present disclosure.

FIG. 19 illustrates a planar view of another exemplary display panel consistent with various disclosed embodiments in the present disclosure.

FIG. 20 illustrates a cross-sectional view along an F-F′ direction of a display panel in FIG. 19 consistent with various disclosed embodiments in the present disclosure.

FIG. 21 illustrates a planar view of another exemplary display panel consistent with various disclosed embodiments in the present disclosure.

FIG. 22 illustrates a planar view of another exemplary display panel consistent with various disclosed embodiments in the present disclosure.

FIG. 23 illustrates an exemplary display device consistent with various disclosed embodiments in the present disclosure.

### DETAILED DESCRIPTION

Reference will now be made in detail to exemplary embodiments of the disclosure, which are illustrated in the accompanying drawings. Hereinafter, embodiments consistent with the disclosure will be described with reference to drawings. In the drawings, the shape and size may be exaggerated, distorted, or simplified for clarity. Wherever possible, the same reference numbers will be used throughout the drawings to refer to the same or like parts, and a detailed description thereof may be omitted. Further, in the present disclosure, the disclosed embodiments and the features of the disclosed embodiments may be combined under conditions without conflicts. It is apparent that the embodiments described are some but not all of the embodiments of the present disclosure. Based on the disclosed embodiments, those ordinarily skilled in the art may derive other embodiments consistent with the present disclosure, all of which are within the scope of the present disclosure.

Moreover, the present disclosure is described with reference to schematic diagrams. For the convenience of descriptions of the embodiments, the cross-sectional views illustrating the device structures may not follow the common proportion and may be partially exaggerated. Besides, those schematic diagrams are merely examples, and not intended to limit the scope of the disclosure. Furthermore, a three-dimensional (3D) size including length, width, and depth should be considered during practical fabrication.

In the present disclosure, terms such as “center”, “longitudinal”, “lateral”, “length”, “width”, “thickness”, “up”, “down”, “front”, “back”, “left”, “right”, “vertical”, “horizontal”, “top”, “bottom”, “inside”, “outside”, “clockwise”, “counterclockwise”, “axial”, “radial”, “circumferential”, etc., indicate orientations or positional relationships based on the orientations or positional relationships shown in the accompanying drawings, and are only for the convenience of describing the present disclosure and simplifying the description, and do not indicate or imply that the device or element referred to must have a specific orientation, be constructed and operated in a specific orientation, and therefore should not be understood as limiting the present disclosure.

In the present disclosure, relational terms such as first and second are only used to distinguish one entity or operation from another entity or operation, and do not necessarily require or imply any actual relationship between these entities or operations or order. Moreover, the terms “including”, “comprising” or any other variants thereof are intended to cover non-exclusive inclusion, such that a process, method, article, or device that includes a series of elements includes not only those elements, but also those that are not explicitly listed or further include elements inherent to this process, method, article or equipment. If there are no more restrictions, the elements defined by the sentence “including . . . ” do not exclude the existence of other same elements in the process, method, article, or equipment that includes the elements.

It should be understood that when describing the structure of a component, when a layer or region is referred to as being “on” or “above” another layer or another region, the layer or region may be directly on the other layer or region, or indirectly on the other layer or region, for example, layers/components between the layer or region and another layer or another region. And, for example, when the component is reversed, the layer or region may be “below” or “under” the other layer or region. In the present disclosure, the term “electrical connection” refers to that two components are directly electrically connected with each other, or the two components are electrically connected via one or more other components.

In the present disclosure, unless otherwise clearly specified and limited, the terms “installed”, “connected”, “fixed” and the like appear, should be understood in a broad sense. For example, it can be a fixed connection, a detachable connection, or an integrated connection; it can be a mechanical connection or an electrical connection; it can be a direct connection or an indirect connection through an intermediate medium, it can be the internal connection of two elements or the interaction relationship between two elements, unless otherwise clearly defined. For those skilled in the art, the specific meanings of the above terms in the present disclosure can be understood according to the specific circumstances.

In the present disclosure, when an element is referred to as being “fixed to” or “disposed on” another element, it may be directly on the other element or there may be an intermediate element. When an element is considered to be “connected to” another element, it may be directly connected to the other element or there may be an intermediate element at the same time. If present, the terms “vertical”, “horizontal”, “upper”, “lower”, “left”, “right” and similar expressions are for illustrative purposes only and are not intended to be the only embodiment.

To prevent touch signals from being shielded, a high-resistance film is usually set in a display panel provided by existing technologies. A square resistance of the high-resistance film is relatively high, such that an electrostatic extraction effect of the high-resistance film is poor, which is not conducive to the release of static electricity in the touch display screen, and it is easy to cause static electricity to enter the inside of the display panel, affecting the reliability and life of the display panel. The present disclosure provides a display panel and a display device, to improve the anti-static ability of the display panel.

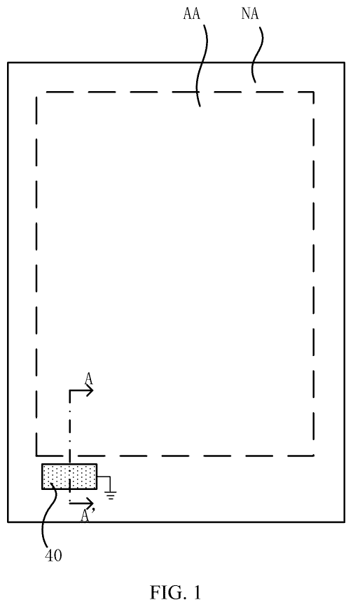

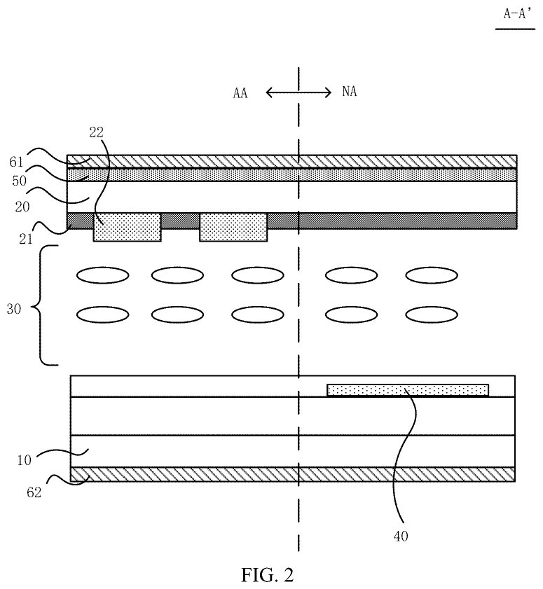

One embodiment of the present disclosure provides a display panel. FIG. 1 is a plan schematic diagram of a display panel provided by the present disclosure, and FIG. 2 is a cross-sectional view of the display panel along an A-A′ direction in FIG. 1. As shown in FIG. 1 and FIG. 2, in one embodiment, the display panel may include: a display area AA, a non-display area NA surrounding the display area AA, a first substrate 10, a second substrate 20, a liquid crystal layer 30, and a conductive portion 40.

The first substrate 10 and the second substrate 20 may be arranged opposite to each other, and a liquid crystal layer 30 may be disposed between the first substrate 10 and the second substrate 20.

The conductive portion 40 may be disposed on a side of the first substrate 10 close to the second substrate 20. The conductive portion 40 may be located in the non-display area NA and may be grounded.

In the present embodiment, the display panel may include the display area AA and the non-display area NA surrounding the display area AA. The display area AA may be used for display. The non-display area NA may not be used for display, and may be used to set circuit structures and the like. The embodiment in FIG. 1 only takes a rectangular display panel as an example. In some other embodiments of the present disclosure, the display panel may also be embodied in other shapes, such as a circular, elliptical, or special-shaped structure. Also, the embodiment in FIG. 1 where the non-display area NA fully surrounds the display area AA is used as an example only for description purposes. Of course, in some other embodiments, the non-display area NA may also semi-surround the display area AA (such as a water drop screen). There is no specific limitation here, and it may be set according to actual needs.

The display panel provided in this embodiment may be a liquid crystal display panel, and the display panel may include the first substrate 10 and the second substrate 20 that are opposite to each other. In one embodiment, the first substrate 10 may be understood as a substrate of an array substrate, and the second substrate 20 may be understood as a substrate of a color filter substrate provided with a color blocking structure and a black matrix structure. As shown in FIG. 2, a black matrix layer 21 and a color blocking layer 22 may be disposed on a side of the second substrate 20 close to the first substrate 10. The color blocking layer 22 may include a plurality of color blockers of different colors, and the plurality of color blockers of different colors may be disposed at a plurality of openings opened in the black matrix layer 21 correspondingly. Of course, in other embodiments of the present disclosure, the first substrate 10 may be understood as a substrate of a color filter substrate (not shown in the figure) provided with a color blocking structure and a black matrix structure, and the second substrate 20 may be understood as a substrate of an array substrate, which will not be repeated here. The liquid crystal layer 30 may be disposed between the first substrate 10 and the second substrate 20, and the liquid crystal layer 30 may include liquid crystal molecules. It can be understood that the liquid crystal molecules of the liquid crystal layer 30 in this embodiment may be positive liquid crystal molecules or negative liquid crystal molecules, which may be set according to actual needs when implemented and will not be repeated here.

In one embodiment, the display panel may be a touch display panel. To ensure that touch signals are not shielded, a high-resistance film 50 may be usually provided on a side of the second substrate 20 away from the first substrate 10. Optionally, the material of the high-resistance film 50 may be ATO (Antimony Tin Oxide, indium oxide doped with tin oxide) or PEDOT (Poly (3,4-ethylenedioxythiophene)). The square resistance of the high-resistance film 50 may be relatively high, such that an electrostatic conduction effect of the high-resistance film 50 is relatively poor, which may easily cause static electricity to enter the interior of the display panel, thereby affecting the reliability and life of the display panel.

The display panel may further include the conductive portion 40, which may be disposed on the side of the first substrate 10 close to the second substrate 20. That is, the conductive portion 40 may be arranged on the side of the first substrate 10 close to the second substrate 20, and the conductive portion 40 may be grounded. The grounded conductive portion 40 may effectively release static electricity accumulation, which may be conducive to improving the anti-static ability of the display panel and preventing static electricity from damaging internal components of the display panel. The conductive portion 40 may be located in the non-display area NA, which may reduce signal crosstalk between the conductive portion 40 and the components in the display area AA, ensure the accuracy of signal transmission in the display area AA, and improve the display effect.

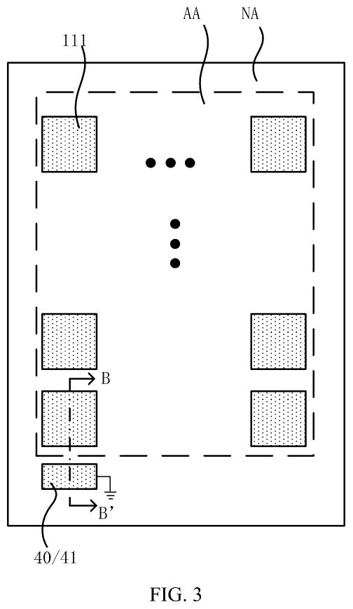

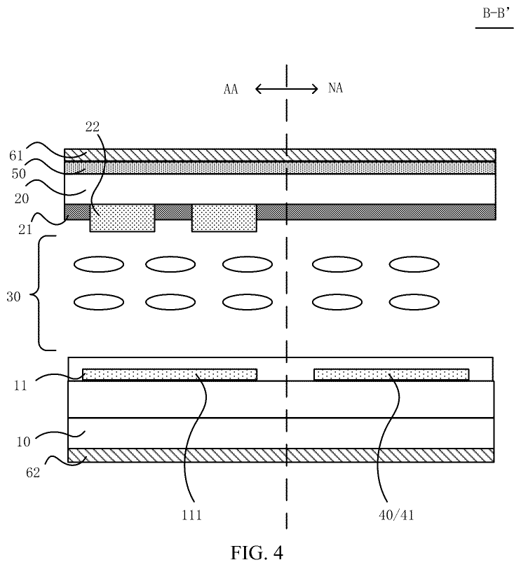

In some embodiments shown in FIG. 3 which is a plan view of another display panel provided by the present disclosure and FIG. 4 which is a cross-sectional view of the display panel along a B-B′ direction in FIG. 3, the display panel may further include a first electrode layer 11. The first electrode layer 11 may be located on the side of the first substrate 10 close to the second substrate 20, and may include a plurality of common electrodes 111. The plurality of common electrodes 111 may be multiplexed as touch electrodes. The plurality of common electrodes 111 may be located in the display area AA.

The conductive portion 40 may include a first conductive portion 41. The first conductive portion 41 may be located in the first electrode layer 11, and may be insulated from the plurality of common electrodes 111. For example, the first electrode layer 11 may be provided on the side of the first substrate 10 close to the second substrate 20, and may include the plurality of common electrodes 111. The plurality of common electrodes 111 may be located in the display area AA, and may be multiplexed as touch electrodes. That is, in a display stage, a common voltage signal may be transmitted to the plurality of common electrodes 111 to realize the display function, and in the touch stage, a touch signal may be transmitted to the plurality of common electrodes 111 to realize the touch function. The plurality of common electrodes 111 may be multiplexed as the touch electrode, which may simplify the structure of the display panel and may be conducive to realizing a thin design of the display panel.

The first electrode layer 11 may be made of materials including a transparent conductive material, such as ITO (Indium Tin Oxides, indium tin oxide semiconductor transparent conductive film), etc., which may be not limited in this embodiment. The plurality of common electrodes 111 of the first electrode layer 11 may be a block structure. It may be understood that the area of one common electrode 111 of the block structure may be larger than the area of a single sub-pixel. That is, one common electrode 111 may correspond to multiple sub-pixels. When the display panel performs touch detection, a detection capacitor may be formed between one common electrode 111 of the block structure and the ground. When a touch subject such as a finger touches the display panel for detection, the capacitance formed between the finger and the capacitor may be superimposed on the common electrode 111 as the touch electrode, thereby forming the coordinates of the touch point and completing the detection of the touch position. It may be understood that the touch detection principle of the display panel may not be elaborated in this embodiment, and when being implemented, it may be understood by referring to the touch principle of the embedded touch display panel in the existing technologies.

The conductive portion 40 may include a first conductive portion 41 which is located in the first electrode layer 11, and the common electrode 111 may also be located in the first electrode layer 11. That is, the first conductive portion 41 and the common electrode 111 may be arranged in the same layer. The first conductive portion 41 and the common electrode 111 may be formed by the same mask process, which is conducive to reducing the process and production cost, and is also conducive to realizing the thin design of the display panel. The first conductive portion 41 and the common electrode 111 may both be located in the first electrode layer 11, and the first conductive portion 41 and the common electrode 111 may be insulated from each other, which may effectively avoid the parasitic capacitance effect and improve the stability of signal transmission.

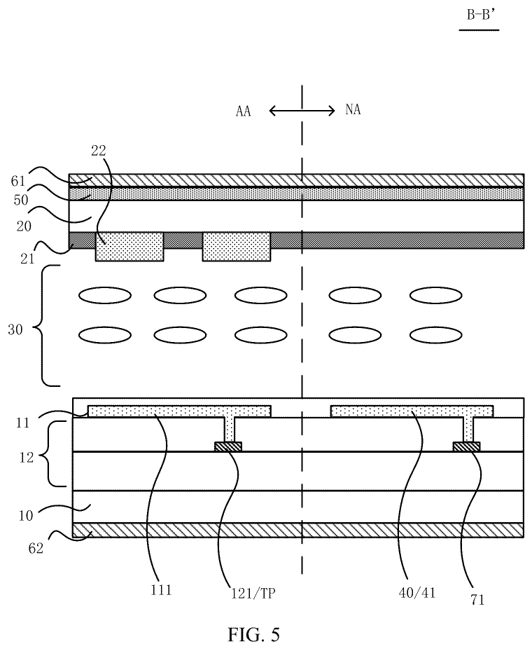

In some optional embodiments shown in FIG. 3 and FIG. 5 which is another cross-sectional view of the display panel along B-B′ in FIG. 3, the display panel may further include an array layer 12, and the array layer 12 may be located between the first substrate 10 and the first electrode layer 11.

The array layer 12 may include a first signal line 71, and the first conductive portion 41 may be electrically connected to the first signal line 71. The first signal line 71 may be grounded.

In some embodiments, the display panel may further include an array layer 12, which is located between the first substrate 10 and the first electrode layer 11. The array layer 12 may include a plurality of circuits. Exemplarily, the array layer 12 may include a plurality of pixel circuits which are electrically connected to the pixel electrodes (not shown in the figure), and the pixel circuits may transmit signals to the pixel electrodes electrically connected thereto.

The first signal line 71 may be provided in the array layer 12, and the first signal line 71 may be grounded. The first conductive portion 41 may be electrically connected to the first signal line 71, to realize the grounding of the first conductive portion 41. The grounded first conductive portion 41 may effectively release static electricity accumulation, which is beneficial to improve the anti-static ability of the display panel and prevent static electricity from damaging the internal components of the display panel.

As shown in FIG. 3 and FIG. 5, in some optional embodiments, the array layer 12 may include a first metal layer 121, and the first metal layer 121 may include a plurality of touch lines TP. The plurality of touch lines TP may be electrically connected to the common electrode 111.

The first signal line 71 may be located in the first metal layer 121.

The array layer 12 may include a first metal layer 121, and the first metal layer 121 may include a plurality of touch lines TP. The plurality of touch lines TP may be electrically connected to the common electrode 111. In the display stage, a common voltage signal may be transmitted to the common electrode 111 through the plurality of touch lines TP to realize the display function. In the touch stage, a touch signal may be transmitted to the common electrode 111 through the plurality of touch lines TP to realize the touch function.

The first signal line 71 may be also located in the first metal layer 121, that is, the first signal line 71 and the plurality of touch lines TP may be arranged in the same layer. The first signal line 71 and the plurality of touch lines TP may be formed by a same mask process, which may be conducive to reducing the process and production cost, and may be conducive to realizing the thin design of the display panel.

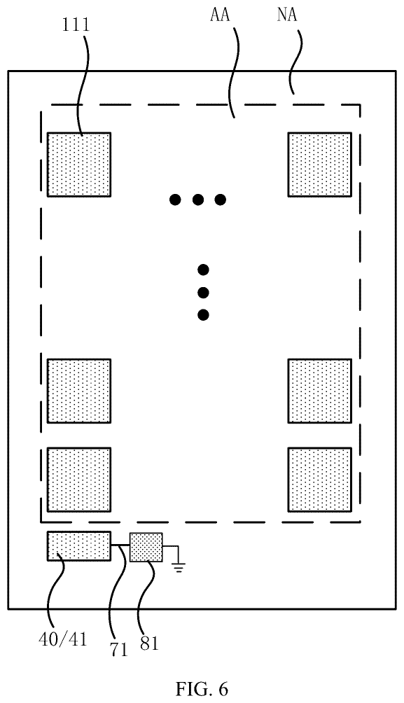

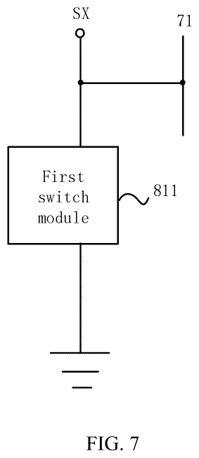

In some embodiment shown in FIG. 6 which is a planar schematic diagram of another display panel provided by the present disclosure and FIG. 7 which is a structural schematic diagram of a first control circuit provided by the present disclosure, the display panel further may include a first control circuit 81, and the first control circuit 81 may include a first switch module 811 and a first control signal terminal SX.

A first terminal of the first switch module 811 may be electrically connected to the first signal line 71 and the first control signal terminal SX, and a second terminal of the first switch module 811 may be grounded.

The display panel may have a display stage and a touch stage.

In the display stage, the first switch module 811 may be turned on and the first signal line 71 may be grounded.

In the touch stage, the first switch module 811 may be turned off, and the first control signal terminal SX may transmit a touch voltage signal to the first signal line 71.

In some embodiments, the display panel may further include the first control circuit 81, and the first control circuit 81 may include the first switch module 811 and the first control signal terminal SX. The first terminal of the first switch module 811 may be electrically connected to the first signal line 71 and the first control signal terminal SX. The first conductive portion 41 may be electrically connected to the first signal line 71. That is, the first terminal of the first switch module 811 may be electrically connected to the first conductive portion 41 and the first control signal terminal SX, and the second terminal of the first switch module 811 may be grounded. When the first switch module 811 is turned on, the first signal line 71 may be grounded, that is, the first conductive portion 41 may be grounded. When the first switch module 811 is turned off, the signal of the first control signal terminal SX may be transmitted to the first signal line 71, that is, the signal of the first control signal terminal SX may be transmitted to the first conductive portion 41.

The display panel may have the display stage and the touch stage. In the display stage, the first switch module 811 may be turned on and the first signal line 71 may be grounded, that is, the first conductive portion 41 may be grounded. The grounded first conductive portion 41 may effectively release static electricity accumulation, which may be conducive to improving the anti-static ability of the display panel and preventing static electricity from damaging the internal components of the display panel.

In the touch stage, the first switch module 811 may be closed, and the signal of the first control signal terminal SX may be transmitted to the first signal line 71. That is, the signal of the first control signal terminal SX may be transmitted to the first conductive portion 41, and the first control signal terminal SX may transmit a touch voltage signal to the first signal line 71. The signal of the first conductive portion 41 may also be the touch voltage signal, which may be conducive to reducing the influence of the first conductive portion 41 on the touch voltage signal of the common electrode 111, and may also be conducive to reducing the influence of the setting of the first conductive portion 41 on the touch accuracy.

As shown in FIG. 6 and FIG. 7, in some optional embodiments, in the display stage, the signal of the common electrode 111 may be the common voltage signal.

In the touch stage, the signal of the common electrode 111 may be the touch voltage signal.

Optionally, in the display stage, the signal of the common electrode 111 in the display panel may be the common voltage signal. The first switch module 811 may be turned on, the first signal line 71 may be grounded. That is, the first conductive portion 41 may be grounded, and the grounded first conductive portion 41 may effectively release static electricity accumulation, which may be conducive to improving the anti-static ability of the display panel and preventing static electricity from damaging the internal components of the display panel. The signal of the first conductive portion 41 may have little effect on the common voltage signal of the common electrode 111 in the display area AA, and may not affect the display effect of the display panel.

In the touch stage, the signal of the common electrode 111 in the display panel may be the touch voltage signal. The first switch module 811 may be turned off, and the signal of the first control signal terminal SX may be transmitted to the first signal line 71. That is, the signal of the first control signal terminal SX may be transmitted to the first conductive portion 41, and the first control signal terminal SX may transmit the touch voltage signal to the first signal line 71. The signal of the first conductive portion 41 may also be the touch voltage signal, which may be conducive to reducing the influence of the first conductive portion 41 on the touch voltage signal of the common electrode 111, and may be conducive to reducing the influence of the setting of the first conductive portion 41 on the touch accuracy.

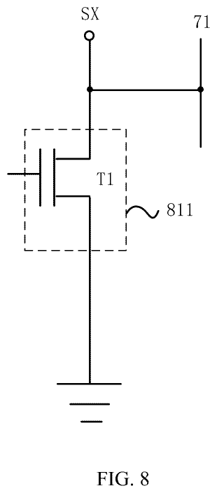

In some other embodiments shown in FIG. 6 and FIG. 8 which is a circuit diagram of another first control circuit provided by the present disclosure, the first switch module 811 may include a first transistor T1, a first electrode of the first transistor T1 may be electrically connected to the first signal line 71 and the first control signal terminal SX, and a second electrode of the first transistor T1 may be grounded.

The first switch module 811 may include the first transistor T1, the first electrode of the first transistor T1 may be electrically connected to the first signal line 71 and the first control signal terminal SX, and the second electrode of the first transistor T1 may be grounded. The first transistor T1 may be turned on and off by transmitting a control signal to the gate of the first transistor T1.

In the display stage, the signal of the common electrode 111 in the display panel may be the common voltage signal. The first transistor T1 may be controlled to be turned on, and the first signal line 71 may be grounded. That is, the first conductive portion 41 may be grounded. The grounded first conductive portion 41 may effectively release static electricity accumulation, which may be beneficial to improve the anti-static ability of the display panel and prevent static electricity from damaging the internal components of the display panel. The signal of the first conductive portion 41 may have little effect on the common voltage signal of the common electrode 111 in the display area AA, and may not affect the display effect of the display panel.

In the touch stage, the signal of the common electrode 111 in the display panel may be the touch voltage signal. The first transistor T1 may be controlled to be turned off, and the signal of the first control signal terminal SX may be transmitted to the first signal line 71. That is, the signal of the first control signal terminal SX may be transmitted to the first conductive portion 41, and the first control signal terminal SX may transmit the touch voltage signal to the first signal line 71. The signal of the first conductive portion 41 may be also the touch voltage signal, which may be beneficial to reduce the influence of the first conductive portion 41 on the touch voltage signal of the common electrode 111, and may be beneficial to reduce the influence of the setting of the first conductive portion 41 on the touch accuracy.

It should be noted that FIG. 8 exemplarily shows that the first switch module 811 includes the first transistor T1, and the first transistor T1 is an N-type MOS transistor. In other embodiments of the present disclosure, the first switch module 811 may also be other switch modules, and the first transistor T1 may also be a P-type MOS transistor. The present disclosure will not repeat them here.

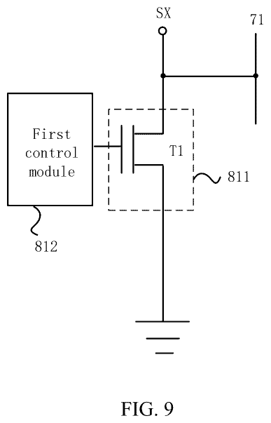

In some other embodiments shown in FIG. 6 and FIG. 9 which is a circuit diagram of another first control circuit provided by the present disclosure, the first control circuit 81 may further include a first control module 812, which is electrically connected to the gate of the first transistor T1, and the first control module 812 may be used to control the state of the first transistor T1.

For example, the first control circuit 81 may further include the first control module 812, the first control module 812 may be electrically connected to the gate of the first transistor T1, the first electrode of the first transistor T1 may be electrically connected to the first signal line 71 and the first control signal terminal SX, the second electrode of the first transistor T1 may be grounded, and the first control module 812 may transmit a control signal to the gate of the first transistor T1 to turn on and off the first transistor T1. That is, the state of the first transistor T1 may be controlled by the first control module 812.

Exemplarily, the first transistor T1 may be an N-type MOS transistor. When the first control module 812 transmits a high-level signal to the gate of the first transistor T1, the first transistor T1 may be turned on. When the first control module 812 transmits a low-level signal to the gate of the first transistor T1, the first transistor T1 may be turned off.

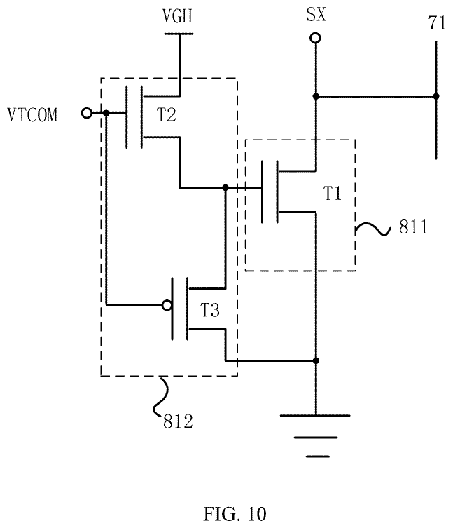

In some other embodiments shown in FIG. 6 and FIG. 10 which is a circuit diagram of another first control circuit provided by the present disclosure, the first control module 812 may include a second transistor T2 and a third transistor T3.

The gate of the second transistor T2 may be electrically connected to the second control signal terminal VTCOM, the first electrode of the second transistor T2 may be electrically connected to the first voltage signal terminal VGH, and the second electrode of the second transistor T2 may be electrically connected to the gate of the first transistor T1.

The gate of the third transistor T3 may be electrically connected to the second control signal terminal VTCOM, the first electrode of the third transistor T3 may be grounded, and the second electrode of the third transistor T3 may be electrically connected to the gate of the first transistor T1.

The signal of the first voltage signal terminal VGH may be a high-level signal.

The first transistor T1 and the second transistor T2 may be NMOS transistors, and the third transistor T3 may be a PMOS transistor.

For example, the first control module 812 may include the second transistor T2 and the third transistor T3, and the first transistor T1 may be an NMOS transistor.

The gate of the second transistor T2 may be electrically connected to the second control signal terminal VTCOM, the first electrode of the second transistor T2 may be electrically connected to the first voltage signal terminal VGH, and the second electrode of the second transistor T2 may be electrically connected to the gate of the first transistor T1. When the second transistor T2 is turned on, the signal of the first voltage signal terminal VGH may be transmitted to the gate of the first transistor T1, and the signal of the first voltage signal terminal VGH may be a high-level signal, such that the first transistor T1 may be turned on.

The gate of the third transistor T3 may be electrically connected to the second control signal terminal VTCOM, the first electrode of the third transistor T3 may be grounded, and the second electrode of the third transistor T3 may be electrically connected to the gate of the first transistor T1. When the third transistor T3 is turned on, the gate of the first transistor T1 may be grounded, so that the first transistor T1 is turned off.

The second transistor T2 may be an NMOS transistor, and the third transistor T3 may be a PMOS transistor. That is, the second transistor T2 and the third transistor T3 may be of opposite types. Therefore, when the signal of the second control signal terminal VTCOM controls the second transistor T2 to turn on, the third transistor T3 may be turned off, and when the signal of VTCOM controls the third transistor T3 to turn on, the second transistor T2 may be turned off.

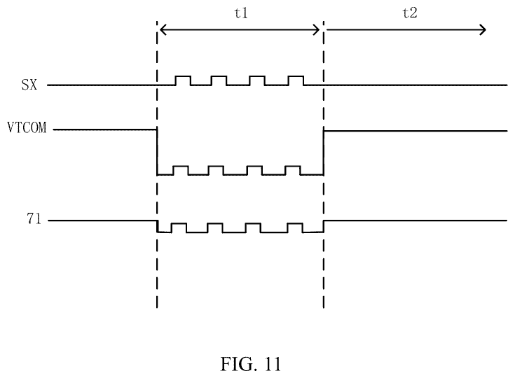

In some embodiments shown in FIG. 6, FIG. 10, and FIG. 11 which is a timing diagram of the first control circuit provided by the present disclosure, the display panel may include a touch stage t1 and a display stage t2.

In the touch stage t1, the signal of the second control signal terminal VTCOM may be a low-level signal, the third transistor T3 may be turned on, the second transistor T2 may be turned off, the gate of the first transistor T1 may be grounded, and the first transistor T1 may be turned off. The signal of the first control signal terminal SX may be transmitted to the first signal line 71, that is, the signal of the first control signal terminal SX may be transmitted to the first conductive portion 41, and the first control signal terminal SX may transmit the touch voltage signal to the first signal line 71. The signal of the first conductive portion 41 may also be the touch voltage signal, which may be conducive to reducing the influence of the first conductive portion 41 on the touch voltage signal of the common electrode 111, and may be conducive to reducing the influence of the setting of the first conductive portion 41 on the touch accuracy.

In the display stage t2, the signal of the second control signal terminal VTCOM may be a high-level signal, the second transistor T2 may be turned on, the third transistor T3 may be turned off, the signal of the first voltage signal terminal VGH may be transmitted to the gate of the first transistor T1, the signal of the first voltage signal terminal VGH may be a high-level signal, such that the first transistor T1 may be turned on, and the first signal line 71 may be grounded. That is, the first conductive portion 41 may be grounded, and the grounded first conductive portion 41 may effectively release static electricity accumulation, which may be conducive to improving the anti-static ability of the display panel and preventing static electricity from damaging the internal components of the display panel. The signal of the first conductive portion 41 may have little effect on the common voltage signal of the common electrode 111 in the display area AA, and may not affect the display effect of the display panel.

In the touch stage t1, the signal of the second control signal terminal VTCOM may be a low-level signal, the third transistor T3 may be turned on, and the third transistor T3 may quickly discharge the charge accumulated between the gate and the first electrode of the first transistor T1, thereby reducing the time for the first transistor T1 to switch between on and off, making the first transistor T1 turn on and off more quickly.

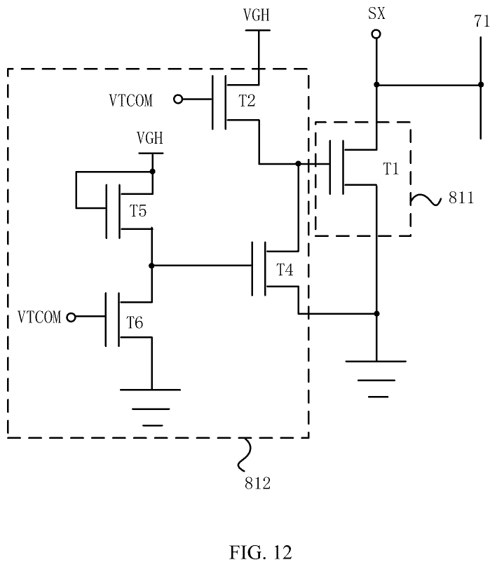

In some other embodiments shown in FIG. 6 and FIG. 12 which is a circuit diagram of another first control circuit provided by the present disclosure, the first control module 812 may include a second transistor T2, a fourth transistor T4, a fifth transistor T5, and a sixth transistor T6;

The gate of the second transistor T2 may be electrically connected to the second control signal terminal VTCOM, the first electrode of the second transistor T2 may be electrically connected to the first voltage signal terminal VGH, and the second electrode of the second transistor T2 may be electrically connected to the gate of the first transistor T1.

The gate of the fourth transistor T4 may be electrically connected to the second electrode of the fifth transistor T5 and the second electrode of the sixth transistor T6, the first electrode of the fourth transistor T4 may be grounded, and the second electrode of the fourth transistor T4 may be electrically connected to the gate of the first transistor T1.

The gate and the first electrode of the fifth transistor T5 may be electrically connected to the first voltage signal terminal VGH.

The gate of the sixth transistor T6 may be electrically connected to the second control signal terminal VTCOM, and the first electrode of the sixth transistor T6 may be grounded.

The signal of the first voltage signal terminal VGH may be a high level signal.

The first transistor T1, the second transistor T2, the fourth transistor T4, the fifth transistor T5 and the sixth transistor T6 may be all NMOS transistors.

For example, the first control module 812 may include the second transistor T2, the fourth transistor T4, the fifth transistor T5 and the sixth transistor T6. The first transistor T1, the second transistor T2, the fourth transistor T4, the fifth transistor T5 and the sixth transistor T6 may be all NMOS transistors. The gate of the second transistor T2 may be electrically connected to the second control signal terminal VTCOM, the first electrode of the second transistor T2 may be electrically connected to the first voltage signal terminal VGH, and the second electrode of the second transistor T2 may be electrically connected to the gate of the first transistor T1. When the second control signal terminal VTCOM is a high-level signal, when the second transistor T2 is turned on, the signal of the first voltage signal terminal VGH may be transmitted to the gate of the first transistor T1, and the signal of the first voltage signal terminal VGH may be a high-level signal, such that the first transistor T1 may be turned on.

The gate of the fourth transistor T4 may be electrically connected to the second electrode of the fifth transistor T5 and the second electrode of the sixth transistor T6, the first electrode of the fourth transistor T4 may be grounded, the second electrode of the fourth transistor T4 may be electrically connected to the gate of the first transistor T1, the gate and the first electrode of the fifth transistor T5 may be electrically connected to the first voltage signal terminal VGH, the gate of the sixth transistor T6 may be electrically connected to the second control signal terminal VTCOM, and the first electrode of the sixth transistor T6 may be grounded. When the second control signal terminal VTCOM is a high level signal, the sixth transistor T6 may be turned on, the gate of the fourth transistor T4 may be grounded, and the fourth transistor T4 may be turned off. When the second control signal terminal VTCOM is a low level signal, the fifth transistor T5 may be turned on, the signal of the first voltage signal terminal VGH may be transmitted to the gate of the fourth transistor T4, the fourth transistor T4 may be turned on, the gate of the first transistor T1 may be grounded, and the first transistor T1 may be turned off.

In some embodiments shown in FIG. 6, FIG. 11 and FIG. 12, the display panel may have a touch stage t1 and a display stage t2.

In the touch stage t1, the signal of the second control signal terminal VTCOM may be a low-level signal, the fifth transistor T5 may be turned on, the signal of the first voltage signal terminal VGH may be transmitted to the gate of the fourth transistor T4, the fourth transistor T4 may be turned on, the gate of the first transistor T1 may be grounded, and the first transistor T1 may be turned off. The signal of the first control signal terminal SX may be transmitted to the first signal line 71, that is, the signal of the first control signal terminal SX may be transmitted to the first conductive portion 41, the first control signal terminal SX may transmit the touch voltage signal to the first signal line 71, and the signal of the first conductive portion 41 may also be the touch voltage signal, which may be conducive to reducing the influence of the first conductive portion 41 on the touch voltage signal of the common electrode 111, and may be conducive to reducing the influence of the setting of the first conductive portion 41 on the touch accuracy.

In the display stage t2, the signal of the second control signal terminal VTCOM may be a high-level signal, the sixth transistor T6 may be turned on, the gate of the fourth transistor T4 may be grounded, the fourth transistor T4 may be turned off, the second transistor T2 may be turned on, the signal of the first voltage signal terminal VGH may be transmitted to the gate of the first transistor T1, the signal of the first voltage signal terminal VGH may be a high-level signal such that the first transistor T1 may be turned on, and the first signal line 71 may be grounded, that is, the first conductive portion 41 may be grounded. The grounded first conductive portion 41 may effectively release static electricity accumulation, which may be conducive to improving the anti-static ability of the display panel and preventing static electricity from damaging the internal components of the display panel. The signal of the first conductive portion 41 may have little effect on the common voltage signal of the common electrode 111 in the display area AA, and may not affect the display effect of the display panel.

Further, the first transistor T1, the second transistor T2, the fourth transistor T4, the fifth transistor T5 and the sixth transistor T6 may be all NMOS transistors, such that the first transistor T1, the second transistor T2, the fourth transistor T4, the fifth transistor T5 and the sixth transistor T6 may be made by the same process, effectively reducing the process and reducing the production cost. The electron mobility of NMOS transistors may be higher, such that their switching speed may be faster. The first transistor T1, the second transistor T2, the fourth transistor T4, the fifth transistor T5, and the sixth transistor T6 may all be NMOS transistors, which may respond to changes in input signals more quickly.

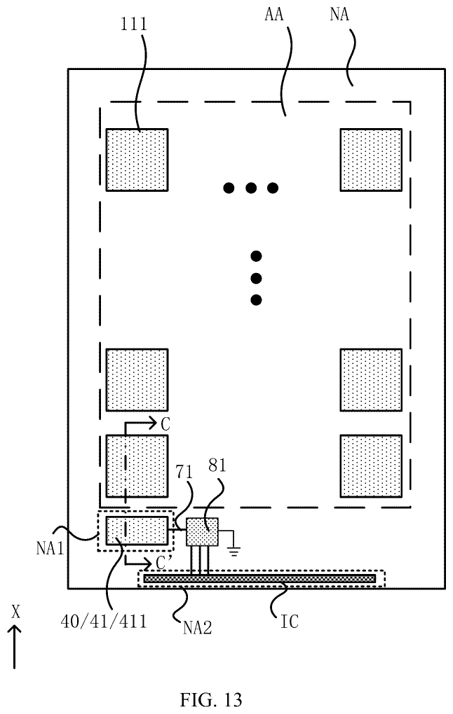

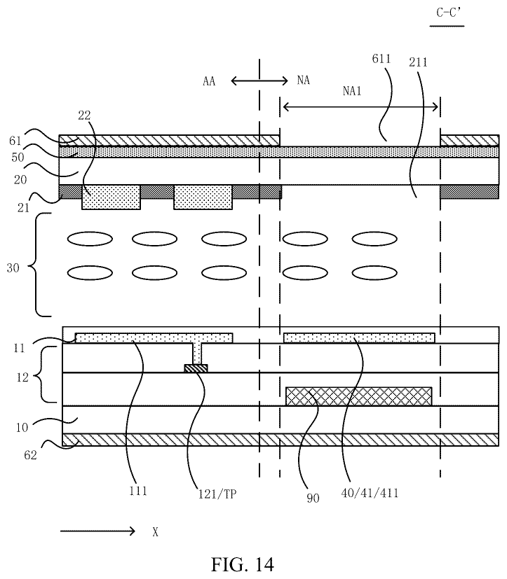

In some embodiments, as shown in FIG. 13 which is a plan view of another display panel provided by the present disclosure, and FIG. 14 which is a cross-sectional view of the display panel described in FIG. 13 along C-C′, the non-display area NA may include a photosensitive recognition area NA1.

The display panel may further include a photosensitive recognition unit 90, which is located on the side of the first substrate 10 close to the second substrate 20, and the photosensitive recognition unit 90 may be disposed in the photosensitive recognition area NA1.

The display panel may further include a first polarizer 61, which is located on a side of the second substrate 20 away from the first substrate 10. The first polarizer 61 may include a first opening 611, and the vertical projection of the first opening 611 on the plane where the first substrate 10 is located may overlap at least partially with the vertical projection of the photosensitive recognition unit 90 on the plane where the first substrate 10 is located.

The first conductive portion 41 may include a first sub-conductive portion 411, and the first sub-conductive portion 411 may be located on a side of the photosensitive recognition unit 90 close to the second substrate 20. The vertical projection of the first sub-conductive portion 411 on the plane where the first substrate 10 is located may overlap at least partially with the vertical projection of the photosensitive recognition unit 90 on the plane where the first substrate 10 is located.

For example, the display panel may include the first polarizer 61, and the first polarizer 61 may be located on the side of the second substrate 20 away from the first substrate 10. The display panel may further include a second polarizer 62, and the second polarizer 62 may be located on the side of the first substrate 10 away from the second substrate 20. The normal light output display of the display panel may be realized by the cooperation of the first polarizer 61 and the second polarizer 62.

The non-display area NA may include the photosensitive recognition area NA1, and the photosensitive recognition unit 90 may be disposed in the photosensitive recognition area NA1. The photosensitive recognition unit 90 may be located on a side of the first substrate 10 close to the second substrate 20, and the photosensitive recognition unit 90 may receive the external ambient light incident through the second substrate 20. The first polarizer 61 may include the first opening 611, and the vertical projection of the first opening 611 on the plane where the first substrate 10 is located may at least partially overlap with the vertical projection of the photosensitive recognition unit 90 on the plane where the first substrate 10 is located. That is, in the area corresponding to the photosensitive recognition unit 90, the first polarizer 61 may be provided with the first opening 611, such that the external light passes through the first opening 611 and enters the photosensitive recognition unit 90, which is conducive to improving the light transmittance, thereby facilitating improving the detection accuracy of the photosensitive recognition unit 90.

Optionally, the black matrix layer 21 may include a second opening 211, and the vertical projection of the second opening 211 on the plane where the first substrate 10 is located may at least partially overlap with the vertical projection of the photosensitive recognition unit 90 on the plane where the first substrate 10 is located. That is, in the area corresponding to the photosensitive recognition unit 90, the black matrix layer 21 may be provided with the second opening 211, such that the external light passes through the second opening 211 and enters the photosensitive recognition unit 90, which may be conducive to improving the transmittance, thereby improving the detection accuracy of the photosensitive recognition unit 90.

Of course, in some other embodiments of the present disclosure, to improve the transmittance and thus improve the detection accuracy of the photosensitive recognition unit, other structural settings may also be adopted in the display panel. For example, liquid crystal molecules may not be set in the area corresponding to the photosensitive recognition unit in the liquid crystal layer, and the present disclosure will not be repeated here.

It should be noted that the structure of the photosensitive recognition unit 90 may not be specifically limited in the present disclosure, and may be set according to actual needs.

The high-resistance film 50 may be usually disposed between the first polarizer 61 and the second substrate 20, and the first polarizer 61 and the high-resistance film 50 may be attached to each other, such static electricity may be easily accumulated on the first polarizer 61, which may be conducive to the static electricity being discharged through the high-resistance film 50. Since the first polarizer 61 may be provided with the first opening 611 in the area corresponding to the photosensitive recognition unit 90, static electricity may not easily accumulate in the area corresponding to the photosensitive recognition unit 90, and the static electricity discharge effect of the part of the high-resistance film 50 corresponding to the photosensitive recognition unit 90 may be poor, and static electricity may be easy to enter the photosensitive recognition unit 90, affecting the reliability and life of the photosensitive recognition unit 90.

The first conductive portion 41 may include the first sub-conductive portion 411, that is, the first sub-conductive portion 411 may be set in the first electrode layer 11, and the first sub-conductive portion 411 may be located on the side of the photosensitive recognition unit 90 close to the second substrate 20. The vertical projection of the first sub-conductive portion 411 on the plane where the first substrate 10 is located may at least partially overlap with the vertical projection of the photosensitive recognition unit 90 on the plane where the first substrate 10 is located. Therefore, in the area corresponding to the photosensitive recognition unit 90, the first sub-conductive portion 411 may effectively release the static electricity accumulation, which may be beneficial to improve the anti-static ability of the display panel, prevent static electricity from entering the photosensitive recognition unit 90, preventing static electricity from damaging the photosensitive recognition unit 90, and effectively improving the reliability and life of the photosensitive recognition unit 90.

Optionally, the vertical projection of the photosensitive recognition unit 90 on the plane where the first substrate 10 is located may be located within the vertical projection of the first sub-conductive portion 411 on the plane where the first substrate 10 is located, such that the first sub-conductive portion 411 may play an electrostatic shielding role for the entire photosensitive recognition unit 90, further preventing static electricity from entering the photosensitive recognition unit 90, thereby preventing static electricity from damaging the photosensitive recognition unit 90 and effectively improving the reliability and life of the photosensitive recognition unit 90.

It should be noted that the grounding setting method of the first sub-conductive portion 411 in the embodiments of the present disclosure may refer to the grounding setting method of the first conductive portion 41 in the above embodiments, and the present disclosure will not be repeated here.

As shown in FIG. 13 and FIG. 14, in some optional embodiments, the non-display area NA may further include a bonding area NA2, and the bonding area NA2 may be located on one side of the display area AA along the first direction X, where the first direction X may be parallel to the plane where the first substrate 10 is located;

The display panel may further include a driver chip IC, and the driver chip IC may be bonded to the side of the first substrate 10 close to the second substrate 20, and the driver chip IC may be located in the bonding area NA2.

Along the first direction X, the photosensitive recognition area NA1 may be located between the display area AA and the bonding area NA2.

For example, the non-display area NA may further include a bonding area NA2. The bonding area NA2 may be located on one side of the display area AA along the first direction X, where the first direction X may be parallel to the plane where the first substrate 10 is located. The driver chip IC may be bonded to the side of the first substrate 10 close to the second substrate 20, and the driver chip IC may be located in the bonding area NA2. The driver chip IC may be used to provide corresponding signals to the photosensitive recognition unit 90, the pixel electrode, the common electrode and the first control circuit 81.

Since the driver chip IC may be used to provide the signal to the photosensitive recognition unit 90, the photosensitive recognition area NA1 may be located between the display area AA and the bonding area NA2 along the first direction X, that is, the photosensitive recognition unit 90 may be arranged between the display area AA and the bonding area NA2, which may be beneficial to reduce the distance between the photosensitive recognition unit 90 and the driver chip IC, thereby helping to reduce the attenuation of the signal transmitted by the driver chip IC to the photosensitive recognition unit 90, and helping to improve the detection accuracy of the photosensitive recognition unit 90.

Optionally, the black matrix layer 21 may include a second opening 211, and the vertical projection of the second opening 211 on the plane where the first substrate 10 is located may at least partially overlap with the vertical projection of the photosensitive recognition unit 90 on the plane where the first substrate 10 is located. That is, in the area corresponding to the photosensitive recognition unit 90, the black matrix layer 21 may be provided with the second opening 211, such that the external light passes through the second opening 211 and enters the photosensitive recognition unit 90, which may be conducive to improving the transmittance, thereby improving the detection accuracy of the photosensitive recognition unit 90.

In other embodiments of the present disclosure, to improve the transmittance and thus improve the detection accuracy of the photosensitive recognition unit, other structural settings may also be adopted in the display panel. For example, liquid crystal molecules may not be provided in the area corresponding to the photosensitive recognition unit in the liquid crystal layer, and the present disclosure will not be repeated here.

The non-display area may further include a bonding area NA2, and along the first direction X, the bonding area NA2 may be located on one side of the display area AA, where the first direction X may be parallel to the plane where the first substrate 10 is located. The driver chip IC may be bonded to the side of the first substrate 10 close to the second substrate 20, and the driver chip IC may be located in the bonding area NA2. The driver chip IC may be used to provide corresponding signals to the photosensitive recognition unit 90, the pixel electrodes and the common electrodes.

To enable the driver chip IC to provide corresponding signals to the photosensitive recognition unit 90, the pixel electrodes and the common electrodes, a fan-out line (not shown in the figure) may be usually set in the display area AA and the bonding area NA2. Along the second direction Y, the photosensitive recognition area NA1 may be located on one side of the display area AA, where the first direction X and the second direction Y intersect. Optionally, the first direction X and the second direction Y may be perpendicular to each other. That is, along the second direction Y, the photosensitive recognition unit 90 may be located on one side of the display area AA, which effectively avoids the mutual influence between the setting of the photosensitive recognition unit 90 and the setting of the fan-out line. The photosensitive recognition unit 90 may have a high signal sensitivity and may be easily affected by other circuit elements such as signals on the fan-out line. Along the second direction Y, the photosensitive recognition unit 90 may be located on one side of the display area AA. Placing the photosensitive recognition unit 90 away from the fan-out line may significantly reduce the risk of signal interference, thereby improving the working accuracy of the photosensitive recognition unit 90.

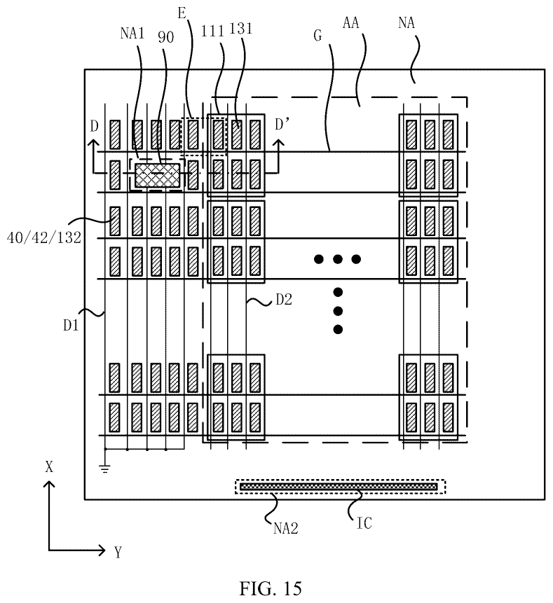

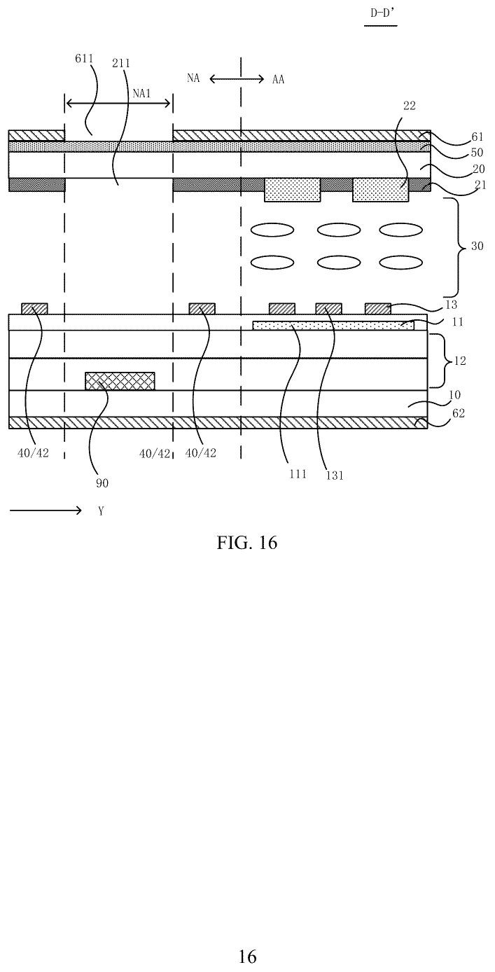

As shown in FIG. 15 and FIG. 16, the high-resistance film 50 may be usually arranged between the first polarizer 61 and the second substrate 20, and the first polarizer 61 and the high-resistance film 50 may be attached to each other. Static electricity may be easily accumulated on the first polarizer 61, which may be conducive to the static electricity being exported through the high-resistance film 50. Since the first polarizer 61 may be provided with the first opening 611 in the area corresponding to the photosensitive recognition unit 90, static electricity may not be easy to accumulate in the area corresponding to the photosensitive recognition unit 90, the static electricity export effect of the part of the high-resistance film 50 corresponding to the photosensitive recognition unit 90 may be poor, and static electricity may be easy to enter the inside of the photosensitive recognition unit 90, affecting the reliability and life of the photosensitive recognition unit 90.

A second conductive portion 42 may be provided around the photosensitive recognition area NA1. The second conductive portion 42 may be located on a side of the photosensitive recognition unit 90 close to the second substrate 20. The second conductive portion 42 may effectively release static electricity accumulation, which may be beneficial to improving the anti-static capability of the display panel and preventing static electricity from entering the photosensitive recognition unit 90, thereby preventing static electricity from damaging the photosensitive recognition unit 90 and effectively improving the reliability and life of the photosensitive recognition unit 90.

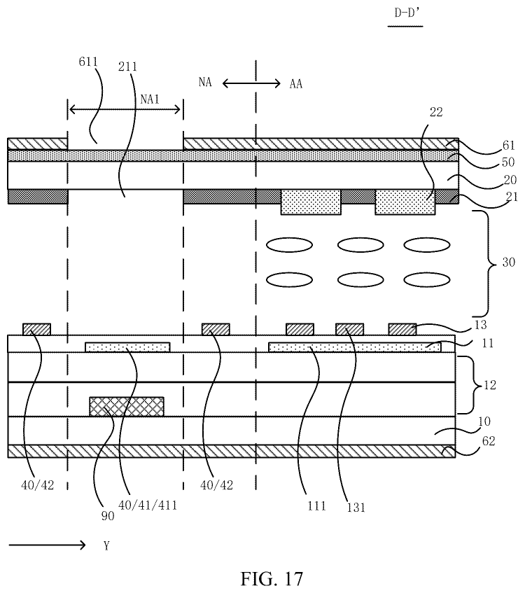

In some optional embodiments shown in FIG. 15 and FIG. 17 which may be another cross-sectional view of the display panel along D-D′ in FIG. 15, when the photosensitive recognition area NA1 may be located on one side of the display area AA along the second direction Y, a first sub-conductive portion 411 may be provided in the photosensitive recognition area NA1. The first sub-conductive portion 411 may be located on the side of the photosensitive recognition unit 90 close to the second substrate 20. The first sub-conductive portion 411 may effectively release static electricity accumulation, which may be beneficial to improving the anti-static ability of the display panel, preventing static electricity from entering the photosensitive recognition unit 90, thereby preventing static electricity from damaging the photosensitive recognition unit 90 and effectively improving the reliability and life of the photosensitive recognition unit 90.

As shown in FIG. 15 and FIG. 17, in some optional embodiments, the conductive portion 40 may include a first sub-conductive portion 411 and a second conductive portion 42. The first sub-conductive portion 411 and the second conductive portion 42 may both be grounded. The grounded first sub-conductive portion 411 and the second conductive portion 42 may effectively release static electricity accumulation, which may be beneficial to further improve the anti-static ability of the display panel and prevent static electricity from damaging the internal components of the display panel.

In the present disclosure, the first sub-conductive portion 411 and the second conductive portion 42 may be provided at the same time, or only the first sub-conductive portion 411 may be provided, or only the second conductive portion 42 may be provided. The setting method of the first sub-conductive portion 411 may refer to the setting method of any first sub-conductive portion 411 in the above embodiments, and the present disclosure will not repeat it here.

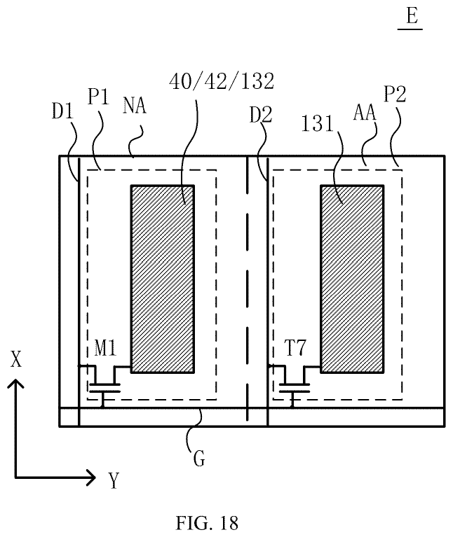

As shown in FIG. 15, FIG. 16 and FIG. 18 which is an enlarged schematic diagram of the E portion of the display panel described in FIG. 15, in some optional embodiments, the display panel may further include a plurality of dummy pixels P1, a plurality of scan lines G, and a plurality of dummy data lines D1. The plurality of dummy pixels P1 may be located in the non-display area NA, and the plurality of dummy pixels P1 may be at least partially arranged around the photosensitive recognition area NA1.

One dummy pixel P1 may include an electrically connected dummy pixel electrode 132 and a dummy transistor M1. The dummy pixel electrode 132 may be reused as the second conductive portion 42. The dummy pixel electrode 132 may be electrically connected to the second electrode of one corresponding dummy transistor M1. The gate of the dummy transistor M1 may be electrically connected to one corresponding scan line G. The first electrode of the dummy transistor M1 may be electrically connected to one corresponding dummy data line D1. The dummy data line D1 may be grounded.

For example, in the display panel, the plurality of dummy pixels P1 may usually be arranged in the non-display area NA and at the edge of the display area AA. One dummy pixel P1 includes an electrically connected dummy pixel electrode 132 and a dummy transistor M1. The dummy pixel electrode 132 may be arranged in the same layer as the pixel electrode 131. The dummy pixel electrode 132 may be electrically connected to the second electrode of the dummy transistor M1. The gate of the dummy transistor MI may be electrically connected to the scan line G. The first electrode of the dummy transistor MI may be electrically connected to the dummy data line D1. The on and off of the dummy transistor M1 electrically connected thereto may be controlled by the signal of the scan line G. When the dummy transistor M1 is turned on, the signal of the dummy data line D1 may be transmitted to the dummy pixel electrode 132 electrically connected thereto.

The plurality of dummy pixels P1 may be arranged around the photosensitive identification area NA1, and accordingly, dummy pixel electrodes 132 may be arranged around the vertical projection of the photosensitive identification unit 90 on the first substrate 10. In the display stage, the dummy transistor M1 electrically connected thereto may be controlled to be turned on by the scanning signal of the scanning line G, and the signal of the dummy data line D1 may be transmitted to the dummy pixel electrode 132 electrically connected thereto. The dummy data line D1 may be grounded, that is, the dummy pixel electrode 132 may be grounded, and the dummy pixel electrode 132 may effectively release static electricity accumulation, which may be beneficial to improving the anti-static ability of the display panel, preventing static electricity from entering the interior of the photosensitive identification unit 90, thereby preventing static electricity from damaging the photosensitive identification unit 90, and effectively improving the reliability and life of the photosensitive identification unit 90.

The multiplexed dummy pixel electrode 132 may be the second conductive portion 42. Therefore, there may be no need to set up the second conductive portion 42 separately, which may simplify the structure of the display panel and may be beneficial to realizing the thin design of the display panel.

It should be noted that FIG. 15 only shows the situation where the plurality of dummy pixels P1 is arranged completely around the photosensitive recognition area NA1. Of course, in some other embodiments, the plurality of dummy pixels P1 may also be arranged only partially around the photosensitive recognition area NA1, which is not specifically limited here and may be set according to actual needs.

As shown in FIG. 15, FIG. 16 and FIG. 18, in some optional embodiments, the display panel may further include a plurality of sub-pixels P2 and a plurality of data lines D2 arranged in an array. One sub-pixel P2 may include an electrically connected pixel electrode 131 and a seventh transistor T7. The pixel electrode 131 may be electrically connected to the second electrode of the seventh transistor T7, the gate of the seventh transistor T7 may be electrically connected to one corresponding scan line G, and the first electrode of the seventh transistor T7 may be electrically connected to one corresponding data line D2.

For example, the display panel may further include the plurality of sub-pixels P2 and the plurality of data lines D2 arranged in an array. The plurality of sub-pixel P2 may be located in the display area AA. One sub-pixel P2 may include the electrically connected pixel electrode 131 and the seventh transistor T7. The pixel electrode 131 may be electrically connected to the second electrode of the seventh transistor T7, the gate of the seventh transistor T7 may be electrically connected to the corresponding scan line G, and the first electrode of the seventh transistor T7 may be electrically connected to the corresponding data line D2. The on or off of the seventh transistor T7 electrically connected thereto may be controlled by the scan signal of the scan line G, and when the seventh transistor T7 is turned on, the signal of the data line D2 may be transmitted to the pixel electrode 131 electrically connected thereto. In the display stage, the seventh transistor T7 electrically connected to the scan line G may be turned on by controlling the signal of the scan line G, and the pixel voltage signal may be transmitted to each pixel electrode 131 through the data line D2, such that an electric field that drives the liquid crystal molecules of the liquid crystal layer 30 to deflect may be formed between the pixel electrode 131 and the common electrode 111, thereby controlling the light emission through the deflection of the liquid crystal molecules and achieving the display effect of the display panel.

The plurality of sub-pixel P2 and the plurality of dummy pixel P1 may be formed using the same process, which effectively reduces the process and production costs. The scan line G electrically connected to the sub-pixel P2 may be multiplexed as the scan line G of the dummy pixel P1, which may be conducive to reducing the difficulty of wiring.

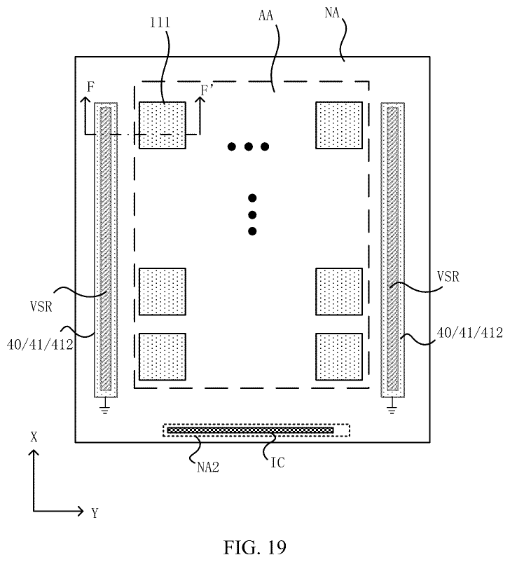

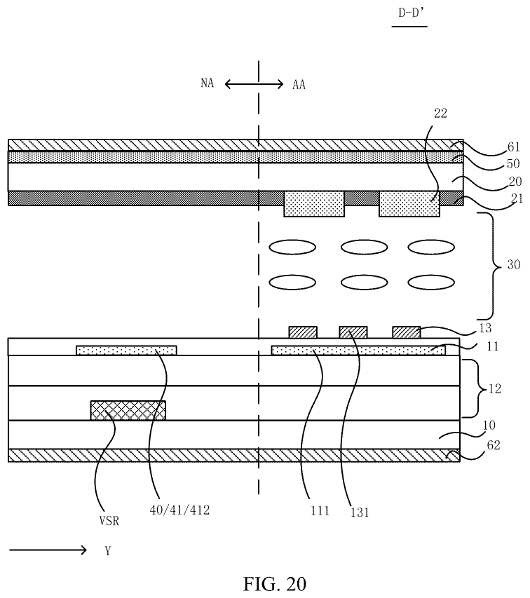

In some optional embodiments shown in FIG. 19 which a planar schematic diagram of another display panel provided by the present disclosure and FIG. 20 which is another cross-sectional view of the display panel described in FIG. 19 along F-F′, the non-display area NA may further include a bonding area NA2, and the bonding area NA2 may be located on one side of the display area AA along the first direction X, where the first direction X may be parallel to the plane where the first substrate 10 is located;

The display panel may further include a driver chip IC, and the driver chip IC may be located in the bonding area NA2.

The display panel may further include a shift register VSR electrically connected to the driver chip IC, and the shift register VSR may be located in the non-display area NA. Along the second direction Y, the shift register VSR may be located on at least one side of the display area AA, where the first direction X and the second direction Y intersect.

The first conductive portion 41 may further include a second sub-conductive portion 412, and the vertical projection of the second sub-conductive portion 412 on the plane where the first substrate 10 is located may at least partially overlap with the vertical projection of the shift register VSR on the plane where the first substrate 10 is located.

For example, the display panel may further include a driver chip IC and a shift register VSR electrically connected to the driver chip IC, and the driver chip IC may provide a signal to the shift register VSR. Exemplarily, the driver chip IC may provide a clock signal, a trigger signal, a high level signal, a low level signal, etc. to the shift register VSR. The shift register VSR may be used to provide a scan signal to the scan line, such that the scan line may provide a scan signal to the sub-pixel electrically connected thereto. The driver chip IC may be located in the bonding area NA2. Along the first direction X, the bonding area NA2 may be located on one side of the display area AA. The shift register VSR may be located in the non-display area NA. Along the second direction Y, the shift register VSR may be located on at least one side of the display area AA, where the first direction X and the second direction Y intersect. Optionally, in one embodiment, the first direction X and the second direction Y may be perpendicular to each other.

The first conductive portion 41 may further include a second sub-conductive portion 412, which may be located on the side of the shift register VSR close to the second substrate 20. The vertical projection of the second sub-conductive portion 412 on the plane where the first substrate 10 is located may at least partially overlap with the vertical projection of the shift register VSR on the plane where the first substrate 10 is located, such that the second sub-conductive portion 412 may effectively release the static electricity accumulation in the area corresponding to the shift register VSR, which may be beneficial to improve the anti-static ability of the display panel, prevent static electricity from entering the inside of the shift register VSR, thereby preventing static electricity from damaging the shift register VSR, effectively improving the reliability and life of the shift register VSR, and ensuring the normal operation of the sub-pixels in the display panel, which may be beneficial to improving the display effect.

Optionally, the vertical projection of the shift register VSR on the plane where the first substrate 10 is located may be located within the vertical projection of the second sub-conductive portion 412 on the plane where the first substrate 10 is located, such that the second sub-conductive portion 412 may play the role of electrostatic shielding for the entire shift register VSR, further preventing static electricity from entering the interior of the shift register VSR, preventing static electricity from damaging the shift register VSR, and effectively improving the reliability and life of the shift register VSR.

It should be noted that the grounding setting method of the second sub-conductive portion 412 in the embodiments of the present disclosure may refer to the grounding setting method of the first conductive portion 41 in the above embodiments, and the present disclosure will not be repeated here.

It should be noted that FIG. 19 exemplarily shows that the shift register VSR may be set on both sides of the display area AA along the second direction Y. In other embodiments of the present disclosure, the shift register VSR may also be set only on one side of the display area AA along the second direction Y, and the present disclosure will not be repeated here.

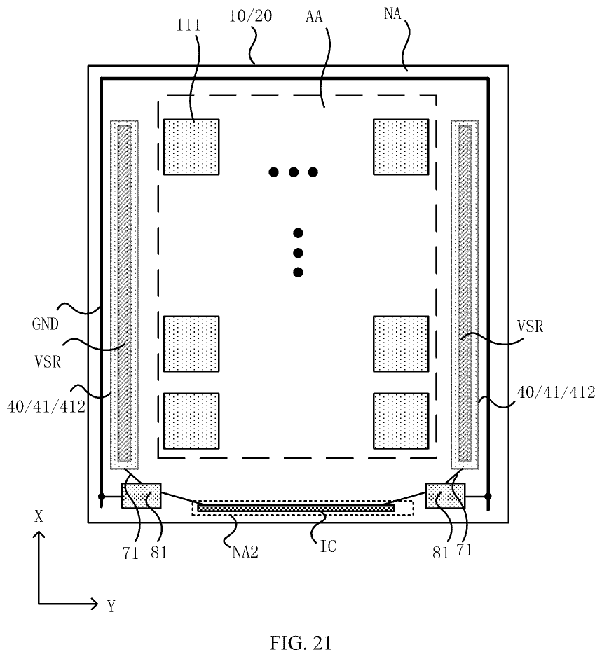

In some optional embodiments, as shown in FIG. 7 and FIG. 21 which is a planar schematic diagram of another display panel provided by the present disclosure, the display panel further may include an electrostatic protection line GND, which may be located in the non-display area NA. Along the second direction Y, the shift register VSR may be located between the electrostatic protection line GND and the display area AA, and the electrostatic protection line GND may be grounded.

The display panel may further include a first control circuit 81, which may include a first switch module 811 and a first control signal terminal SX.

At least one first control circuit 81 may be electrically connected to the second sub-conductive portion 412. In the first control circuit 81, the first end of the first switch module 811 may be electrically connected to the second sub-conductive portion 412 and the first control signal terminal SX, and the second end of the first switch module 811 may be electrically connected to the electrostatic protection line GND.

For example, the display panel may further include the electrostatic protection line GND, which may be located in the non-display area NA. Along the second direction Y, the shift register VSR may be located between the electrostatic protection line GND and the display area AA. The electrostatic protection line GND may be grounded. When static electricity is generated at the edge of the display panel, the static electricity may be guided out through the electrostatic protection line GND, thereby improving the electrostatic protection capability of the display panel.

The display panel may further include the first control circuit 81, which may be electrically connected to the second sub-conductive portion 412. The first control circuit 81 may include a first switch module 811 and a first control signal terminal SX. The first end of the first switch module 811 may be electrically connected to the second sub-conductive portion 412 and the first control signal terminal SX, and the second end of the first switch module 811 may be electrically connected to the electrostatic protection line GND. When the first switch module 811 is turned on, the signal of the electrostatic protection line GND may be transmitted to the second sub-conductive portion 412 via the first signal line 71. The electrostatic protection line GND may be grounded. That is, the second sub-conductive portion 412 may be grounded. When the first switch module 811 is turned off, the signal of the first control signal terminal SX may be transmitted to the first signal line 71, that is, the signal of the first control signal terminal SX may be transmitted to the second sub-conductive portion 412.

The display panel may have a display stage and a touch stage. In the display stage, the first switch module 811 may be turned on, and the signal of the electrostatic protection line GND may be transmitted to the second sub-conductive portion 412 via the first signal line 71. The electrostatic protection line GND may be grounded, that is, the second sub-conductive portion 412 may be grounded. The grounded second sub-conductive portion 412 may play an electrostatic shielding role for the shift register VSR, preventing static electricity from entering the shift register VSR, thereby preventing static electricity from damaging the shift register VSR, and effectively improving the reliability and life of the shift register VSR.

In the touch stage, the first switch module 811 may be turned off, and the signal of the first control signal terminal SX may be transmitted to the first signal line 71. That is, the signal of the first control signal terminal SX may be transmitted to the second sub-conductive portion 412, and the first control signal terminal SX may transmit the touch voltage signal to the first signal line 71. The signal of the second sub-conductive portion 412 may be also the touch voltage signal, which may be conducive to reducing the influence of the second sub-conductive portion 412 on the touch voltage signal of the common electrode 111, and may be conducive to reducing the influence of the setting of the second sub-conductive portion 412 on the touch accuracy.

The second end of the first switch module 811 may be electrically connected to the electrostatic protection line GND, and the electrostatic protection line GND may be grounded. That is, the signal of the electrostatic protection line GND may be multiplexed to realize the grounding of the second end of the first switch module 811, without adding a special grounding line, which may reduce the wiring complexity, thereby simplifying the overall circuit layout, effectively saving the space required for wiring in the non-display area NA, and being conducive to achieving a narrow frame.

It should be noted that the circuit structure of the first control circuit 81 in the embodiment of the present disclosure may refer to the circuit structure of the first control circuit 81 in any of the above embodiments, and the present disclosure will not be repeated here.

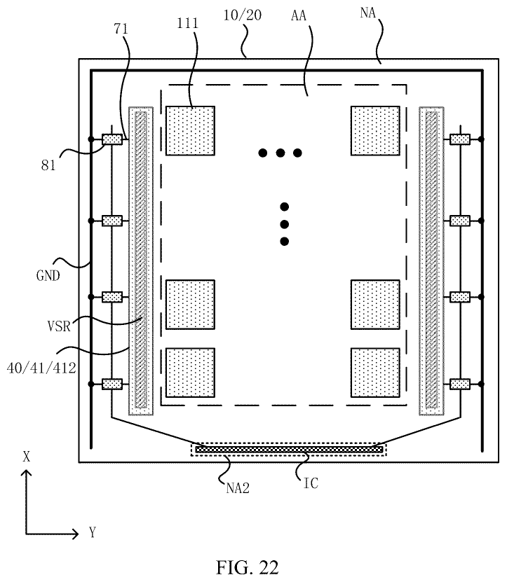

FIG. 22 is a plan view of another display panel provided by the present disclosure. As shown in FIG. 22, in some optional embodiments, one same second sub-conductive portion 412 may be electrically connected to multiple first control circuits 81.

Since the size of the shift register VSR in the display panel is relatively large, to improve the electrostatic shielding effect of the second sub-conductive portion 412 on the shift register VSR, the size of the second sub-conductive portion 412 may also be set to be relatively large. One same second sub-conductive portion 412 may be electrically connected to multiple first control circuits 81, and the second sub-conductive portion 412 may be driven simultaneously by multiple first control circuits 81, which may significantly improve the driving capability and ensure that the signal response of the second sub-conductive portion 412 is more stable and reliable.

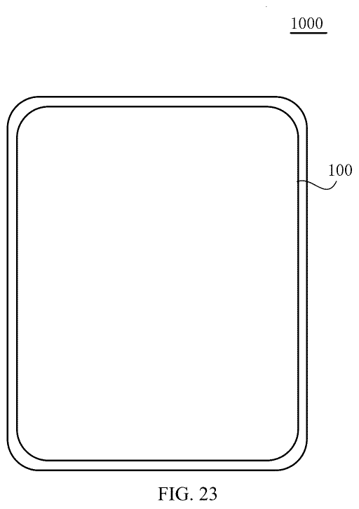

The present disclosure also provides a display device. As shown in FIG. 23 which is a schematic diagram of a structure of a display device consistent with the embodiments of the present disclosure, in one embodiment, the display device 1000 may include a display panel 100 provided by any of the above embodiments. The embodiment shown in FIG. 23 where the display device 1000 is a cell phone is used as an example to illustrate the present disclosure only, and does not limit the scope of the present disclosure. In various embodiments, the display device 1000 provided by the embodiment of the present disclosure may be any electronic device with a display function, including but being not limited to, cell phones, televisions, laptops, desktop displays, tablet computers, digital cameras, smart bracelets, smart glasses, car displays, medical equipment, industrial control equipment, touch interactive terminals, etc.

The display device 1000 provided by the embodiments of the present disclosure may have the beneficial effects of the display panel 100 provided by the embodiments of the present disclosure. For details, references may be made to the specific description of the display panel 100 in the above embodiments, which will not be repeated here.

In the present disclosure, relational terms such as “first” and “second” are only used to distinguish one entity or operation from another entity or operation, and do not necessarily require or imply that there is a relationship between these entities or operations. There is no such actual relationship or sequence. Furthermore, the terms “comprises”, “include”, or any other variations thereof are intended to cover a non-exclusive inclusion such that a process, method, article, or apparatus that includes a list of elements includes not only those elements, but also those not expressly listed, or elements inherent to the process, method, article or equipment. Without further limitation, an element defined by the statement “comprises a . . . ” does not exclude the presence of additional identical elements in a process, method, article, or apparatus that includes the stated element.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the disclosure. Thus, while the present disclosure has been described in detail with reference to the above described embodiments, the present disclosure is not limited to the above described embodiments, but may be embodied in other equivalent forms without departing from the scope of the present disclosure, which is determined by the appended claims.

1. A display panel, comprising:
a display area and a non-display area surrounding the display area;
a first substrate and a second substrate arranged opposite to each other;
a liquid crystal layer located between the first substrate and the second substrate;
a high-resistance film on a side of the second substrate away from the first substrate; and
a conductive portion on a side of the first substrate close to the second substrate, wherein the conductive portion is located in the non-display area and is grounded.

2. A display panel, comprising:
a display area and a non-display area surrounding the display area;
a first substrate and a second substrate arranged opposite to each other;
a liquid crystal layer located between the first substrate and the second substrate;
a conductive portion on a side of the first substrate close to the second substrate, wherein the conductive portion is located in the non-display area and is grounded; and
a first electrode layer, wherein:
the first electrode layer is located on the side of the first substrate close to the second substrate;
the first electrode layer includes a plurality of common electrodes, wherein the plurality of common electrodes are multiplexed as touch electrodes and are located in the display area; and
the conductive portion includes a first conductive portion, wherein the first conductive portion is located in the first electrode layer and is insulated from the plurality of common electrodes.

3. The display panel according to claim 2, further including an array layer, wherein:
the array layer is located between the first substrate and the first electrode layer;
the array layer includes a first signal line; and
the first conductive portion is electrically connected to the first signal line, wherein the first signal line is grounded.

4. The display panel according to claim 3, wherein:
the array layer includes a first metal layer, wherein the first metal layer includes a plurality of touch lines and the plurality of touch lines are electrically connected to the plurality of common electrodes; and
the first signal line is located in the first metal layer.

5. The display panel according to claim 3, further including a first control circuit, wherein:
the first control circuit includes a first switch module and a first control signal terminal;
a first terminal of the first switch module is electrically connected to the first signal line and the first control signal terminal, and a second terminal of the first switch module is grounded;
the display panel has a display stage and a touch stage;
in the display stage, the first switch module is turned on and the first signal line is grounded; and
in the touch stage, the first switch module is turned off and the first control signal terminal transmits a touch voltage signal to the first signal line.

6. The display panel according to claim 5, wherein:
in the display stage, the signal of the plurality of common electrodes is a common voltage signal;
in the touch stage, the signal of the plurality of common electrodes is the touch voltage signal.

7. The display panel according to claim 5, wherein:
the first switch module includes a first transistor, wherein: a first electrode of the first transistor is electrically connected to the first signal line and the first control signal terminal, and a second electrode of the first transistor is grounded.

8. The display panel according to claim 7, wherein:
the first control circuit further includes a first control module;
the first control module is electrically connected to a gate of the first transistor; and
the first control module is used to control the state of the first transistor.

9. The display panel according to claim 8, wherein:
the first control module includes a second transistor and a third transistor;
a gate of the second transistor is electrically connected to the second control signal terminal, a first electrode of the second transistor is electrically connected to the first voltage signal terminal, and a second electrode of the second transistor is electrically connected to the gate of the first transistor;
a gate of the third transistor is electrically connected to the second control signal terminal, a first electrode of the third transistor is grounded, and a second electrode of the third transistor is electrically connected to the gate of the first transistor;
the signal of the first voltage signal terminal is a high-level signal; and
the first transistor and the second transistor are NMOS transistors, and the third transistor is a PMOS transistor.

10. The display panel according to claim 8, wherein:
the first control module includes a second transistor, a fourth transistor, a fifth transistor, and a sixth transistor;
a gate of the second transistor is electrically connected to the second control signal terminal, a first electrode of the second transistor is electrically connected to the first voltage signal terminal, and a second electrode of the second transistor is electrically connected to the gate of the first transistor;
a gate of the fourth transistor is electrically connected to a second electrode of the fifth transistor and a second electrode of the sixth transistor, a first electrode of the fourth transistor is grounded, and a second electrode of the fourth transistor is electrically connected to the gate of the first transistor;
a gate and a first electrode of the fifth transistor are electrically connected to the first voltage signal terminal;
a gate of the sixth transistor is electrically connected to the second control signal terminal, and a first electrode of the sixth transistor is grounded;
the signal of the first voltage signal terminal is a high level signal; and
the first transistor, the second transistor, the fourth transistor, the fifth transistor and the sixth transistor are all NMOS transistors.

11. The display panel according to claim 2, further including a photosensitive recognition unit and a first polarizer, wherein:
the non-display area includes a photosensitive recognition area;
the photosensitive recognition unit is located on the side of the first substrate close to the second substrate, and the photosensitive recognition unit is located in the photosensitive recognition area;
the first polarizer is located on a side of the second substrate away from the first substrate;
the first polarizer includes a first opening, wherein a vertical projection of the first opening on a plane where the first substrate is located overlaps with a vertical projection of the photosensitive recognition unit on the plane where the first substrate is located; and
the first conductive portion includes a first sub-conductive portion located on a side of the photosensitive recognition unit close to the second substrate, wherein a vertical projection of the first sub-conductive portion on the plane where the first substrate is located overlaps with the vertical projection of the photosensitive recognition unit on the plane where the first substrate is located.

12. The display panel according to claim 11, further including a driver chip, wherein:
the non-display area further includes a bonding area;
along a first direction, the bonding area is located on one side of the display area, wherein the first direction is parallel to the plane where the first substrate is located;
the driver chip is bonded to the side of the first substrate close to the second substrate, and the driver chip is located in the bonding area; and
along the first direction, the photosensitive recognition area is located between the display area and the bonding area.

13. A display panel, comprising:
a display area and a non-display area surrounding the display area;
a first substrate and a second substrate arranged opposite to each other;
a liquid crystal layer located between the first substrate and the second substrate;
a conductive portion on a side of the first substrate close to the second substrate, wherein the conductive portion is located in the non-display area and is grounded; and
a second electrode layer, wherein:
the second electrode layer is located on the side of the first substrate close to the second substrate;
the second electrode layer includes a plurality of pixel electrodes, wherein the plurality of pixel electrodes is located in the display area; and
the conductive portion includes a second conductive portion, wherein the second conductive portion is located in the second electrode layer and is insulated from the plurality of pixel electrodes.

14. The display panel according to claim 13, wherein:
the non-display area includes a photosensitive recognition area;
the display panel further includes a photosensitive recognition unit, wherein the photosensitive recognition unit is located on the side of the first substrate close to the second substrate and is located in the photosensitive recognition area;
the display panel further includes a first polarizer located on the side of the second substrate away from the first substrate, wherein the first polarizer includes a first opening and a vertical projection of the first opening on a plane where the first substrate is located at least partially overlaps with a vertical projection of the photosensitive recognition unit on the plane where the first substrate is located;
the non-display area further includes a bonding area located on one side of the display area along a first direction, wherein the first direction is parallel to the plane where the first substrate is located;
the display panel further includes a driver chip bonded to the side of the first substrate close to the second substrate, wherein the driver chip is located in the bonding area; and
along a second direction, the photosensitive recognition area is located on one side of the display area, wherein the first direction and the second direction intersect.

15. The display panel according to claim 14, further including a plurality of dummy pixels, a plurality of scan lines, and a plurality of dummy data lines, wherein:
the plurality of dummy pixels is located in the non-display area, and is at least partially arranged around the photosensitive recognition area; and
one dummy pixel includes a dummy pixel electrode and a dummy transistor electrically connected, wherein: the dummy pixel electrode is multiplexed as the second conductive portion and is electrically connected to a second electrode of the dummy transistor, a gate of the dummy transistor is electrically connected to one corresponding scan line, a first electrode of the dummy transistor is electrically connected to one corresponding dummy data line, and the dummy data line is grounded.

16. The display panel according to claim 15, further including a plurality of sub-pixels arranged in an array and a plurality of data lines, wherein:
one sub-pixel includes a pixel electrode and a seventh transistor which are electrically connected, wherein: the pixel electrode is electrically connected to a second electrode of the seventh transistor, a gate of the seventh transistor is electrically connected to one corresponding scan line, and the first electrode of the seventh transistor is electrically connected to one corresponding data line.

17. The display panel according to claim 2, wherein:
the non-display area further includes a bonding area located on one side of the display area along a first direction, wherein the first direction is parallel to the plane where the first substrate is located;
the display panel further includes a driver chip, which is located in the bonding area;
the display panel further includes a shift register electrically connected to the driver chip, which is located in the non-display area, wherein: along a second direction, the shift register is located on at least one side of the display area, and the first direction and the second direction intersect; and
the first conductive portion further includes a second sub-conductive portion located on a side of the shift register close to the second substrate, wherein a vertical projection of the second sub-conductive portion on the plane where the first substrate is located at least partially overlaps with a vertical projection of the shift register on the plane where the first substrate is located.

18. The display panel according to claim 17, wherein:
the display panel further includes an electrostatic protection line, which is located in the non-display area, wherein: along the second direction, the shift register is located between the electrostatic protection line and the display area, and the electrostatic protection line is grounded;
the display panel further includes first control circuits, wherein one first control circuit includes a first switch module and a first control signal terminal;
at least one of the first control circuits is electrically connected to the second sub-conductive portion, wherein: a first end of the first switch module is electrically connected to the second sub-conductive portion and the first control signal terminal, and a second end of the first switch module is electrically connected to the electrostatic protection line.

19. The display panel according to claim 18, wherein:
the same second sub-conductive portion is electrically connected to multiple first control circuit.

20. A display device, comprising the display panel according to claim 1.
